(19) United States
(12) Patent Application Publication
(10) Pub. No.: US 2026/0101196 A1
(43) Pub. Date: Apr. 9, 2026

(54) METASURFACE REFLECTORS AND METHODS OF WIRELESS NETWORK CONFIGURATION FOR WIRELESS SIGNAL COVERAGE IMPROVEMENT

(71) Applicant: ANI Acquisition Sub, LLC, Boca Raton, FL (US)

(72) Inventors: Solomon Tesfay Abraha, Corning, NY (US); Viacheslav Viacheslavovich Ivanov, Espoo (FI); Anthony Ng'oma, Horseheads, NY (US); Aleksandr Volkov, Espoo (FI)

(73) Assignee: ANI Acquisition Sub, LLC, Boca Raton, FL (US)

(21) Appl. No.: 19/349,382

(22) Filed: Oct. 3, 2025

Related U.S. Application Data
(60) Provisional application No. 63/702,763, filed on Oct. 3, 2024.

(51) Int. Cl. H04W 16/20; H04B 7/04

(52) U.S. Cl. CPC H04W 16/20; H04B 7/04013

(57) ABSTRACT

In one embodiment, a metasurface reflector array includes a primary metasurface reflector operable to be positioned on a first surface to reflect a primary node beam from a radio node positioned on a second surface transverse to the first surface, where a center of the primary metasurface reflector has a first vertical offset on the first surface, a pair of secondary metasurface reflectors operable to be positioned on adjacent sides of the primary metasurface reflector, each secondary metasurface reflector of the pair of secondary metasurface reflectors operable to reflect a secondary node beam from the radio node, where a center of each secondary metasurface reflector has a second vertical offset on the first surface that is greater than the first vertical offset, and a pair of tertiary metasurface reflectors operable to be positioned on adjacent sides of the pair of secondary metasurface reflectors.

### CROSS-REFERENCE TO RELATED APPLICATIONS

This application claims the benefit of priority under 35 U.S.C. § 119 (e) of U.S. Provisional Application No. 63/702,763, filed Oct. 3, 2024, the contents of which are incorporated herein by reference in its entirety.

### BACKGROUND

Poor signal coverage provided by wireless networks, such as 5G mmWave communication systems, is a well know issue in the wireless industry. Conventional wireless networks position the radio node on the ceiling in the center of a room, such as an office space. These wireless networks attempt to account for poor signal coverage by increasing transmitted power, adding additional radio nodes, increasing infrastructure wiring, all of which increase system complexity, power consumption, and total cost of ownership.

Accordingly, alternative wireless network systems may be desired.

### SUMMARY

In one embodiment, a metasurface reflector array includes a primary metasurface reflector operable to be positioned on a first surface to reflect a primary node beam from a radio node positioned on a second surface transverse to the first surface, where a center of the primary metasurface reflector has a first vertical offset dz1 on the first surface, a pair of secondary metasurface reflectors operable to be positioned on adjacent sides of the primary metasurface reflector, each secondary metasurface reflector of the pair of secondary metasurface reflectors operable to reflect a secondary node beam from the radio node, where a center of each secondary metasurface reflector has a second vertical offset dz2 on the first surface that is greater than the first vertical offset dz1, and a pair of tertiary metasurface reflectors operable to be positioned on adjacent sides of the pair of secondary metasurface reflectors, each tertiary metasurface reflector of the pair of tertiary metasurface reflectors operable to reflect a tertiary node beam from the radio node, where a center of each tertiary metasurface reflector has a third vertical offset dz3 on the first surface that is less than the second vertical offset dz2 and greater than the first vertical offset z1.

In another embodiment, a method of positioning one or more metasurface reflectors on a first surface relative to a radio node positioned on a second surface that is transverse to the first surface includes emitting, by the radio node, a radio node beam having an elevation steering angle θ and an azimuth steering angle φ, varying the elevation steering angle θ over a plurality of angle values, and for each elevation steering angle θ, varying a horizontal distance from the radio node to the first surface over a plurality of distance values resulting in a plurality of angle value and distance pairs. The method also includes, for each angle value and distance value pair, calculating a beam gain for a plurality of points within an area on the surface, determining a peak gain location within the area providing a maximum beam gain, determining a flux metric F for a plurality of virtual frame positions at the second surface, where each virtual frame position has an area defined by a metasurface reflector and encompasses the peak gain location, determining an individual virtual frame position among the plurality of virtual frame positions providing a maximum flux metric F, selecting an individual angle value and distance pair resulting in a largest maximum flux metric F among the plurality of angle value and distance pairs, positioning the radio node on the second surface at a distance from the first surface according to the individual angle value and distance pair. The method also includes positioning the metasurface reflector on the first surface at a location according to the individual frame position providing the maximum flux metric F of the individual angle value and distance pair.

In another embodiment, a wireless communication system includes a radio node configured to emit radio node beams, a primary metasurface reflector operable to be positioned on a first surface to reflect a primary node beam from the radio node positioned on a second surface transverse to the first surface, where a center of the primary metasurface reflector has a first vertical offset dz1 on the first surface, a pair of secondary metasurface reflectors operable to be positioned on adjacent sides of the primary metasurface reflector, each secondary metasurface reflector of the pair of secondary metasurface reflectors operable to reflect a secondary node beam from the radio node, where a center of each secondary metasurface reflector has a second vertical offset dz2 on the first surface that is greater than the first vertical offset dz1. The system also includes a pair of tertiary metasurface reflectors operable to be positioned on adjacent sides of the pair of secondary metasurface reflectors, each tertiary metasurface reflector of the pair of tertiary metasurface reflectors operable to reflect a tertiary node beam from the radio node, where a center of each tertiary metasurface reflector has a third vertical offset dz3 on the first surface that is less than the second vertical offset dz2 and greater than the first vertical offset z1.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a side view of an example wireless communication system according to one or more embodiments described and illustrated herein.

FIG. 2 illustrates a front view of the example wireless communication system of FIG. 1 according to one or more embodiments described and illustrated herein.

FIG. 3 illustrates a flowchart of an example method for optimally positioning components of a wireless communication system according to one or more embodiments described and illustrated herein.

FIG. 4 illustrates an example incident beam node and a virtual frame disposed around peak gain location according to one or more embodiments described and illustrated herein.

FIG. 5 illustrates a graph plotting integral electric flux versus radio node-metasurface reflector according to one or more embodiments described and illustrated herein.

FIG. 6 illustrates a graph plotting maximum integral electric flux versus radio node beam steering elevation according to one or more embodiments described and illustrated herein.

FIG. 7 illustrates an example reflector array according to one or more embodiments described and illustrated herein.

FIG. 8 graphically illustrates the optimized beam gain in the metasurface reflector plane defined by the vertical z and horizontal y directions according to one or more embodiments described and illustrated herein.

FIG. 9 illustrates an example metasurface reflector according to one or more embodiments described and illustrated herein.

FIG. 10A illustrates a top view of an example unit cell of a metasurface reflector according to one or more embodiments described and illustrated herein.

FIG. 10B illustrates a side view of an example unit cell of a metasurface reflector according to one or more embodiments described and illustrated herein.

FIG. 11 illustrates two plots of forward gain versus azimuth and elevation steering angles for a horizontally polarized source node beam according to one or more embodiments described and illustrated herein.

FIG. 12 illustrates two plots of forward gain versus azimuth and elevation steering angles for a vertically polarized source node beam according to one or more embodiments described and illustrated herein.

FIG. 13A illustrates a three-dimensional directivity plot of a metasurface reflector excited by a horizontally polarized source at 28 GHz according to one or more embodiments described and illustrated herein.

FIG. 13B illustrates a three-dimensional directivity plot of a metasurface reflector excited by a vertically polarized source at 28 GHz according to one or more embodiments described and illustrated herein.

FIG. 14A illustrates a graph plotting phase response verses conductive loop length for a plurality of incident angles of a horizontally polarized source according to one or more embodiments described and illustrated herein.

FIG. 14B illustrates a graph plotting phase response verses conductive loop length for a plurality of incident angles of a horizontally polarized source according to one or more embodiments described and illustrated herein.

FIG. 15A illustrates a graph plotting amplitude response verses conductive loop length for a plurality of incident angles of a horizontally polarized source according to one or more embodiments described and illustrated herein.

FIG. 15B illustrates a graph plotting amplitude response verses conductive loop length for a plurality of incident angles of a vertically polarized source according to one or more embodiments described and illustrated herein.

FIG. 16A graphically illustrates angle φf incidence on a metasurface reflector for horizontal polarization (top) and vertical polarization (bottom) according to one or more embodiments described and illustrated herein.

FIG. 16B graphically illustrates the phase response of a metasurface reflector for horizontal polarization (top) and vertical polarization (bottom) according to one or more embodiments described and illustrated herein.

FIG. 16C graphically illustrates the amplitude response of a metasurface reflector for horizontal polarization (top) and vertical polarization (bottom) according to one or more embodiments described and illustrated herein.

FIG. 16D illustrates the lengths of horizontal conductive loops (top) and lengths of vertical conductive loops (bottom) of a metasurface reflector according to one or more embodiments described and illustrated herein.

FIG. 17 illustrates a graph plotting peak directivity versus frequency for a metasurface reflector according to one or more embodiments described and illustrated herein.

FIG. 18 illustrates graphs plotting directivity versus azimuth angle φf steering (top) and elevation angle φf steering (bottom) for a metasurface reflector according to one or more embodiments described and illustrated herein.

FIG. 19 illustrates a graph plotting the cumulative distribution functions versus reference signal received power for three scenarios according to one or more embodiments described and illustrated herein.

### DETAILED DESCRIPTION

Embodiments of the present disclosure are directed to metasurface reflectors and methods of optimizing and placing metasurface reflectors and radio nodes in spaces for optimal performance. Optimization processes are disclosed to determine placement of both a radio node (i.e., a source antenna array) close to a surface, such as a wall, operation of steering angles (elevation and azimuth), and placement of a metasurface reflector on the wall to optimally reflect an incident node beam of the radio node. The metasurface reflector has a specially designed surface comprising an array of unit cells that are configured to manipulate the phase and/or amplitude of the reflected beam for maximum coverage.

More particularly, embodiments of the present disclosure assume the presence of a small source radio node and exploits metasurface reflectors which are larger in size (i.e., having a larger aperture) compared to the radio node. Each metasurface reflector is capable to change spatial structure of the beam emitted from the radio node for more favorable propagation, similar to reflector antennas, but with finer design for indoor environments by means of special phase-engineering of metasurface reflector. The shape of the reflected beam scattered from the metasurface reflector is optimized for the best coverage in the target deployment area.

The metasurface reflector design of embodiments of the present disclosure considers simultaneous optimization of the position of the metasurface reflector relative to the radio node, as well as the radio node emitted beam direction of steering. An example result of such optimization is a central metasurface reflector which is designed to be installed at, for example, a distance just 30 cm horizontally and 60 cm down vertically from the radio node. Such design allows exploitation of high radiation efficiency of a radio node beam having a small steering angle φf just 30 degrees. The result of the optimization may vary depending on the performance of the radio node beams radiated at different steering angles at different carrier frequencies. Current solutions do not consider improved capability of the directivity control appearing from the differences in sizes between radio node antenna array and the size of the metasurface reflector.

Further, embodiments leverage the compensation of the near-field features of the beam emitted from the radio node, which accommodates the very short distance between the radio node and the metasurface reflector, resulting in varying angles of incidence upon the metasurface reflector over different locations of the metasurface reflector. The metasurface reflector design also incorporates directivity shaping of the scattered beam in terms of angular widths in azimuth and elevation directions individually. The resulting scattered beam width in elevation of the designed reflector may be twice narrower than typical a 4×8/8×8 antenna-array emitted beam width (8 degrees vs 12-20 degrees). This allows energy concentration and propagation farther away, which is allowed by reduced impact of spherical spreading, as the beam wavefront becomes almost planar with assistance of the larger-aperture of the metasurface reflector. The azimuth width of the scattered beam is wider than that of the emitted beam and is optimized for a typical indoor office deployment of 60×20 meters with system near the center of a 20 meter wall, for example.

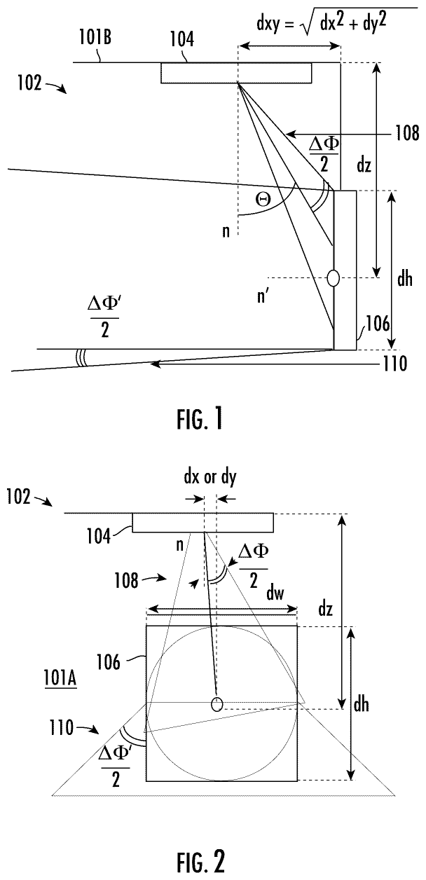

Referring now to FIG. 1, an example wireless communication system 102 is schematically illustrated in a side view. The wireless communication system 102 may be operable to provide wireless communication to a plurality of users within an environment, such as users of electronic devices (e.g., laptop computers, desktop computers, tablet computers, mobile phones, Internet-of-Things devices, and the like) within an environment, such as an office space, a lobby, a conference room, and the like. The wireless communication system 102 of FIG. 1 includes a radio node 104 positioned on a second surface 101B, and a metasurface reflector 106 on a first surface 101A that is transverse to the second surface 101B. The second surface 101B may be a ceiling and the first surface 101A may be a wall, for example. In the illustrated embodiment the second surface 101B is orthogonal to the first surface 101A; however, embodiments are not limited thereto. The second surface 101B may intersect the first surface 101A at a non-orthogonal angle, for example.

The radio node 104 is operable to emit a node beam 108 that is received and reflected by the metasurface reflector 106.

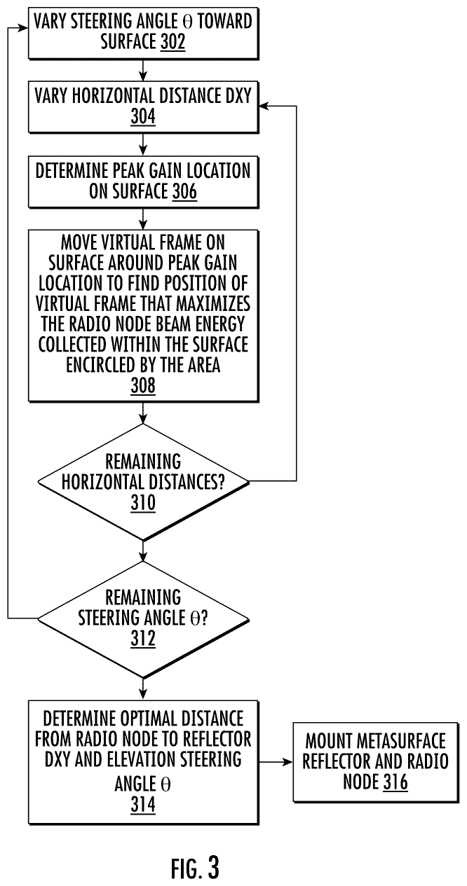

FIG. 2 illustrates the example wireless communication system 102 of FIG. 1 in a front view (i.e., facing the metasurface reflector 106). Referring to both FIG. 1 and FIG. 2, the metasurface reflector 106 is positioned on the first surface 101A such that its center point is separated from the second surface 101B by a vertical distance dz, and has a vertical dimension dh and a horizontal dimension dw. Distances dx or dy represent a horizontal offset of the metasurface reflector 106 with respect to a center point of the radio node 104, depending on the wall orientation in the XY floor plane. The radio node 104 has a normal n, and the metasurface reflector 106 has a normal n′.

The radio node 104 is operable to produce a radio node beam 108 toward the metasurface reflector 106 at a plurality of steering angles determined by angle pair of the elevation steering angle θ and the azimuth steering angle ¢. The elevation steering angle θ is the angle between radio node 104 normal n and the incidence point on the metasurface reflector 106 in the z direction. The azimuth steering angle φ is the angle between the radio node 104 normal n and the incidence point on the metasurface reflector 106 in the x or y direction. Dimension dxy is the distance from the radio node 104 to the second surface on which the metasurface reflector 106 is mounted.

Dimensions Δθ and Δφ are the radio node angular beam widths before incidence on the metasurface reflector 106 along elevation and azimuth, respectively. Δθ′ and Δφ′ are the radio node angular beam widths after scattering by the metasurface reflector 106 along elevation and azimuth, respectively.

The radio node 104 is capable of producing a radio beam 108, such as, without limitation, a 5G mmWave radio beam for a 5G mmWave communication system 102. The radio node 104 may be a single source radio node 104 which uses beam switching (i.e., a beamforming codebook) to produce multiple radio beams 108 toward the metasurface reflector 106 at different locations. Additionally, the radio node 104 may produce a radio beam 108 having dual polarization. As described in more detail below, the metasurface reflector 106 is designed to have a phase response to optimally reflect the incident node beam 114 according to specific angles of incidence.

Embodiments of the present disclosure are directed to methods for optimally positioning the metasurface reflector 106 on the first surface 101A so that a maximum area of coverage in an environment is achieved. Referring now to FIG. 3, an example method of optimally positioning components of a wireless communication system 102 is illustrated. It is noted that the method illustrated by FIG. 3 may be performed in an anechoic RF chamber. Initially, a radio node 104 is positioned at an initial position on a second surface 101B of the anechoic RF chamber with respect to the first surface 101A as illustrated by FIG. 1 and FIG. 2. The radio node 104 is operated to produce a radio node beam 108 toward the first surface 101A at a plurality of elevation steering angles θ over a range of elevation steering angles θ at block 302. As a non-limiting example, the range of elevation steering angles θ may be zero degrees to 90 degrees. Additionally, a horizontal distance dxy between radio node 104 and the second surface 101B is varied over a range of distances at block 304, such as, without limitation, 20 cm to 10 meters.

Thus, for each elevation steering angle θ the horizontal distance dxy is varied, which produces a plurality of angle value θ and horizontal distance dxy pairs.

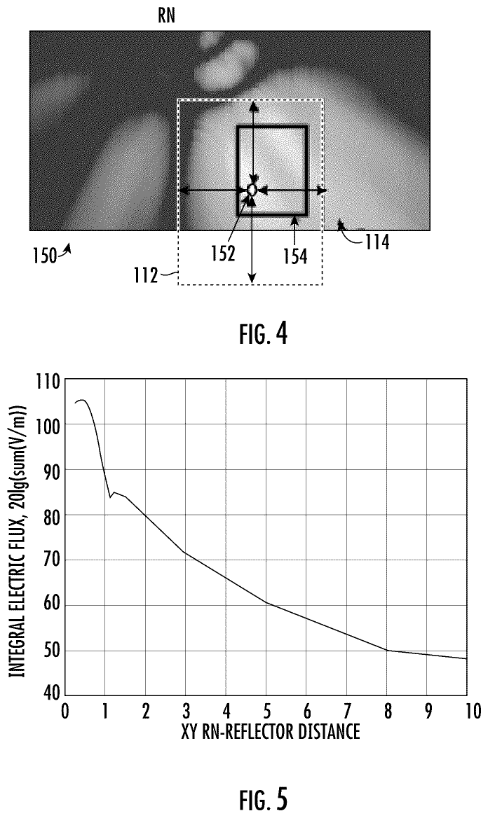

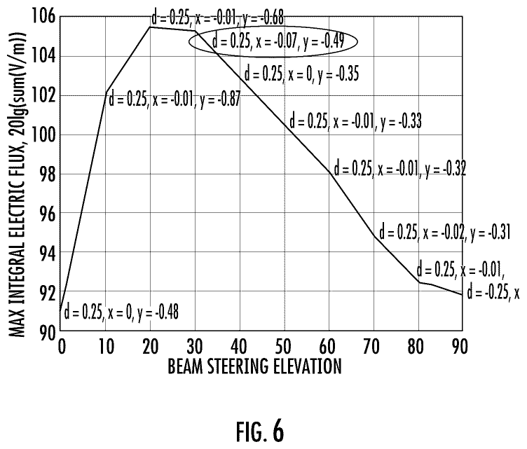

For each angle value θ and horizontal distance dxy pair, the beam gain is measured at a plurality of points within a predefined area 150 on the first surface 101A at block 306. FIG. 4 illustrates an incident node beam 114 that is incident on the first surface 101A. The beam gain may be measured a calibrated measurement antenna or any other known or yet-to-be-developed instrument for measuring the beam gain at points within the predefined area 150. As a non-limiting example, the predefined area 150 may be two meters by two meters, although other dimensions are possible.

Still at block 306 a peak gain location 152 is determined. The peak gain location corresponds with a point on the first surface 101A having a maximum beam gain as measured by the measurement antenna.

After the peak gain location 152 is determined for the particular angle value θ and horizontal distance dxy pair, a virtual frame 154 is positioned such that it encompasses the peak gain location 152 at block 308. FIG. 4 illustrates an example virtual frame 154 surrounding the peak gain location 152. The virtual frame 154 is not a physical frame but rather a virtual frame that defines an area over which the beam gain for the plurality of points as measured by the measurement antenna are processed. The virtual frame 154 has an area and shape that is equal to that of the metasurface reflector 106 that is to be mounted on the first surface 101A. Embodiments are not limited to any dimension for the virtual frame/metasurface reflector 106. As a non-limiting example, the virtual frame 154/metasurface reflector 106 may be 35×45 cm. The purpose of the virtual frame 154 and the process at block 308 is to find the optimal location of the virtual frame 154 (and thus the metasurface reflector 106) that maximizes the radio node beam energy that is collected.

At block 308 the virtual frame 154 is moved to a plurality of virtual frame positions in dz and dx or dy. Thus, the virtual frame 154 is moved about the peak gain location 152 in two dimensions, with the ultimate goal of finding the virtual frame position that collects the greatest amount of radio beam energy.

For each virtual frame position an electric flux metric F is calculated. The electric flux metric F reflects the energy collected within a surface area of the virtual frame 154. The electric flux metric F, which is calculated as shown in Eq. 1:

$$F [ V \cdot m ] = \int \int dS [ {meters}^{2} ] \cdot \sqrt{120 π [ Ohm ] \cdot \frac{E I R P [ W ]}{4 {π ( r [ meters ] )}^{2}}} \qquad ( Eq . 1 )$$

$$E I R P [ W ] = {P}_{tx} [ W ] \cdot ( {F}_{θ}^{2} + {F}_{φ}^{2} )$$

Where EIRP is the beam equivalent isotropic reference power in the direction to a point of the surface, r is the distance from the radio node 104 center to the point on the first surface. Integration is done over the surface frame, where dS is the surface area element, 120π Ohm is the impedance of the fre espace. Ptx, is the radiated power out of the antenna, F_{θ} and F_{φ}-antenna field gains in vertical θ and horizontal φ polarizations.

Thus, the result is a plurality of electric flux metric F values resulting from the calculations for the plurality of virtual frame positions. Further at block 308, an individual virtual frame position among the plurality of virtual frame positions providing a maximum flux metric F is determined. This individual virtual frame position represents the best two dimensional location of the metasurface reflector 106 on the first surface 101A for the particular angle value θ and horizontal distance dxy pair.

Next, at block 310 it is determined if there are any remaining horizontal distances dxy remaining for the particular elevation steering angle θ. If yes, the process moves back to block 304 where the horizontal distance dxy is incremented or otherwise varied. If no, the process moves to block 312 where it is determined whether or not there are remaining elevation steering angles θ. If there are remaining elevation steering angles θ, the process moves back to block 302 where the elevation steering angle θ is incremented or otherwise varied. The process will then continue to block 304 and block 306 as described above. It is noted that in some embodiments, varying the horizontal distance dxy occurs at block 302 and varying the elevation steering angle θ occurs at block 304.

When there are no more remaining elevation steering angles θ, the process moves to block 314 where the optimal horizontal distance dxy is determined. This is determined by evaluating all of the maximum flux metric F values that were determined for all of the angle value θ and horizontal distance dxy pairs in the steps of blocks 302-312. Among this set of maximum flux metric F values, the one providing the greatest value is selected. This selected maximum flux metric F value is associated with an individual angle value θ and horizontal distance dxy pair as well as an individual position of the virtual frame 154 in dz and dx or dy. Thus, the optimal horizontal distance dxy, optimal elevation steering angle θ, and optimal location of the metasurface reflector 106 on the first surface 101A are known. At block 316 the metasurface reflector 106 is mounted on the first surface 101A at the optimal location, and the radio node is mounted on the second surface 101B at the optimal horizontal distance dxy from the first surface 101A. During operation, the radio node 104 emits a radio node beam 108 at the optimal elevation steering angle θ.

FIG. 5 is a graph that plots the integral electric flux (i.e., total collected energy) within the virtual frame as a function of the horizontal distance dxy for a given fixed radio node beam angle φf steering [θ, φ]. As shown by FIG. 5, there is an optimal horizontal distance dxy for the given elevation steering angle θ, which is about 0.5 meters.

FIG. 6 is a graph that plots the maximum integral electric flux as a function of beam steering elevation, horizontal distance dxy. For the given horizontal distance dxy, an elevation steering angle θ of 30 degrees provides the maximum integral electric flux.

In FIG. 6, d values are the optimal horizontal distances from Tx antenna to the reflector (referred by dxy in other parts of this document) for each steering elevation angle. The x and y values in FIG. 6 are the optimal positions of the frame within the wall plane, which are determined for a specific pair of elevation steering angle and horizontal distance.

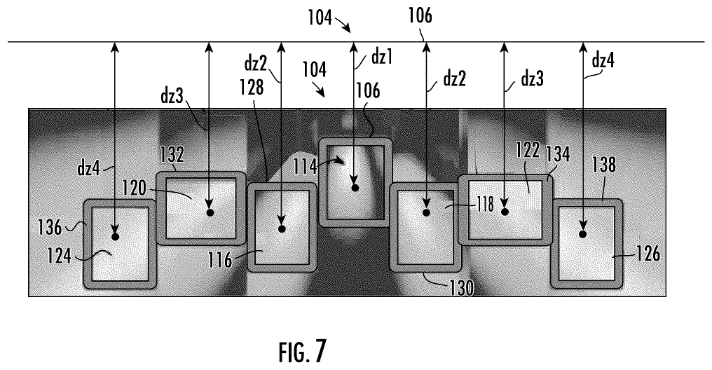

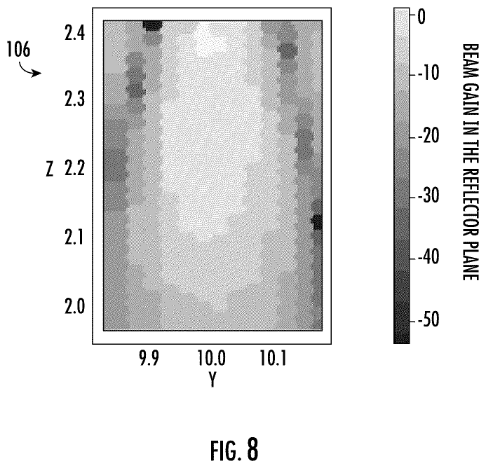

The radio node 104 may be operable to produce multiple node beams according to a beam codebook. FIG. 7 illustrates a first surface 101A having multiple incident node beams in the form of a primary incident node beam 114, a first secondary incident node beam 116, a second secondary incident node beam 118, a first tertiary incident node beam 120, a second tertiary incident node beam 122, a first quaternary incident node beam 124, and a second quaternary incident node beam 126. These node beams may be switched by the radio node 104 according to a codebook. These additional incident node beams may be reflected by a metasurface reflector array comprising additional metasurface reflectors, such as first secondary metasurface reflector 128, second secondary metasurface reflector 130, first tertiary metasurface reflector 132, second tertiary metasurface reflector 134, first quaternary metasurface reflector 136 and second quaternary metasurface reflector 138.

The coverage impact of each additional metasurface reflector is maximized if each additional metasurface reflector collects a section of the respective node beam with peak gain. Thus, in embodiments in the present disclosure, each additional metasurface reflector has its respective beam optimized. In the process for multiple metasurface reflectors, the primary metasurface reflector 106 is positioned according to the process described above with respect to FIG. 4, with the azimuth steering angle φset to zero, which ensures minimal propagation distance from the radio node 104 to the metasurface reflector 106 center. The narrowest radio node beam footprint in the wall plane is also ensured. It is noted that the narrowest possible angular beam width is beneficial for reducing the size of the metasurface reflector, or providing the capability to increase the distance from the metasurface reflector to the radio node 104 (i.e., horizontal distance dxy).

For the next metasurface reflector, such as the first secondary metasurface reflector 128, it will be positioned adjacent to the primary metasurface reflector 106 in a side-by-side relationship. Accordingly, the lateral dx or dy position is fixed based on the location of the primary metasurface reflector 106 on the first surface 101A. The fixed lateral dx or dy position also establishes a fixed azimuth angle φf steering ¢.

The optimization method establishes an optimal elevation steering angle θ and vertical offset dz for the additional metasurface reflector. The vertical offset dz together with the elevation steering angle θ are optimized according to a process similar to that of FIG. 4. During this process, the horizontal position of the reflector dx or dy is kept fixed and the horizontal distance dxy of the radio node 104 to the first surface 101A is the same as was established when determining the location of the primary metasurface reflector 106. Further, the orientation (e.g., portrait or landscape) may be chosen depending on the shape of the incident node beam for the intended additional metasurface reflector. In this process, a peak gain location is determined for each elevation steering angle θ. A virtual frame representing the additional metasurface reflector 106 (e.g., the first secondary metasurface reflector 128) is moved along the vertical direction. An electric flux metric F is calculated for each vertical offset dz (i.e., vertical position) on the first surface 101A for each elevation steering angle θ. Then, a maximum electric flux metric F is determined among the set of electric flux metric F values that were calculated. The elevation steering angle θ and vertical offset dz pair providing the maximum electric flux metric F establishes both the elevation steering angle θ for the additional incident node beam, such as a first secondary node beam 108 and a vertical offset dz2 for the corresponding additional metasurface reflector, such as a first secondary metasurface reflector 128. The additional metasurface reflector may then be mounted

The process is repeated until all of the remaining additional metasurface reflectors are positioned and installed in a side-by-side manner. It is noted that at some point vertical tiling as opposed to horizontal tiling as shown in FIG. 7 may result in larger collected energy. However, the constraints on the minimal installation height of the metasurface reflectors can be imposed to avoid cubical-wall blockage or human blockage, for example.

It is also noted that in some cases a node beam designed for one metasurface reflector also covers an area for another metasurface reflector, which may be more likely with the right-most pair of metasurface reflectors and the left-most pair of metasurface reflectors. The scattered field from one metasurface reflector may impact the scattered field of another, which means that the two metasurface reflectors should be co-designed for joint operation. In the case illustrated by FIG. 4, the right-most pair and the left-most pair of metasurface reflectors may be co-designed and the number of radio node beams reduced.

FIG. 8 shows the optimized beam gain in the metasurface reflector plane defined by the vertical z and horizontal y directions. The metasurface reflector has a dimension of 35×45 cm and is oriented vertically. The gain values shown in FIG. 5 are normalized to the peak gain value. FIG. 5 shows that the incident beam is stretched vertically, and is well captured by the vertically oriented metasurface reflector.

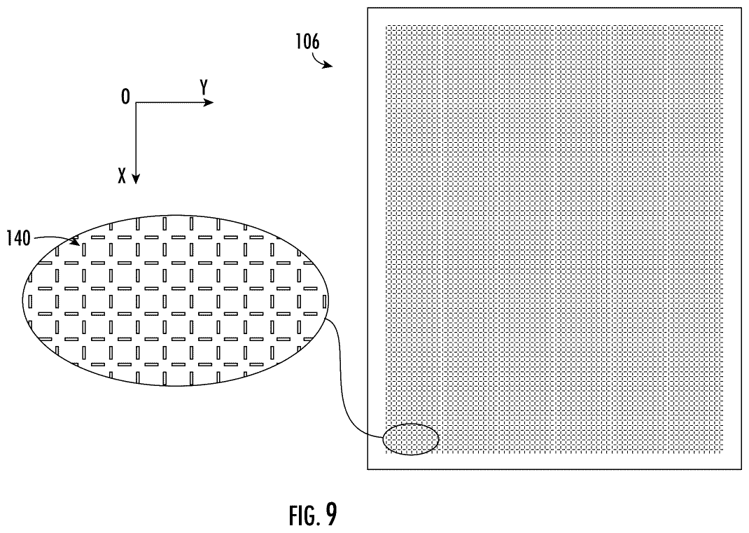

The surfaces of the metasurface reflectors described herein are designed to provide a local phase response to optimally reflect an incident node beam according to specific angles of incidence. Referring now to FIG. 9, the surface of a metasurface reflector 106 comprises an array of unit cells 140 defined by conductive loops on a dielectric substrate, such as glass. The unit cell shapes are optimized by an electromagnetic simulation with a single unit cell repeated infinitely over a surface plane, and targeting specific phase responses of an incident plane waves at specific angles of incidence. The near-field is included by considering different incidence angles for each actual unit cell location, according to the source and reflector relative locations. The metasurface reflector is designed to reshape and redirect an oblique incident EM wave from a dual-polarized phased array. Each unit cell is designed to provide phased distribution for TE and TM polarizations under corresponding incident angles, such as 50 degrees to 70 degrees.

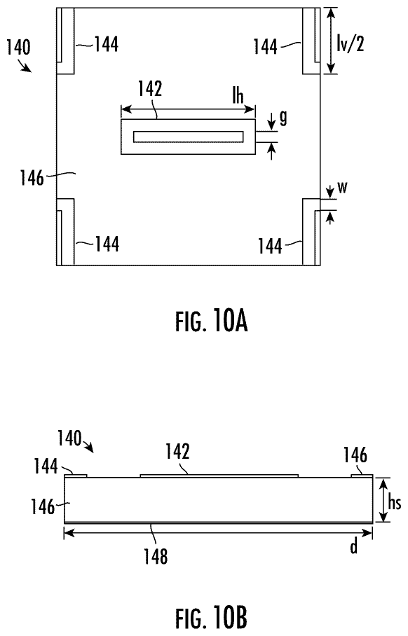

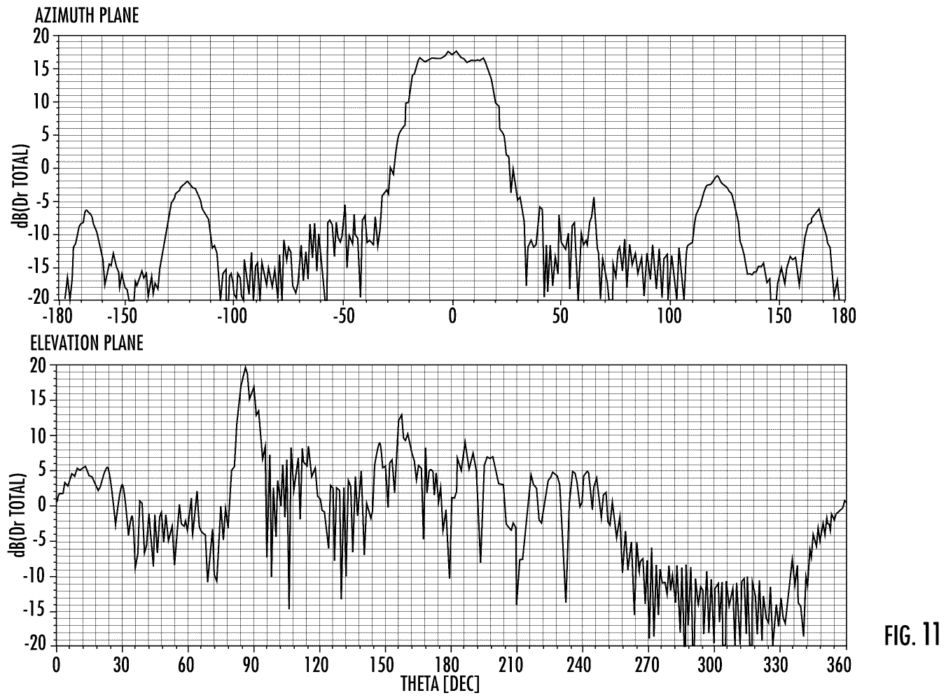

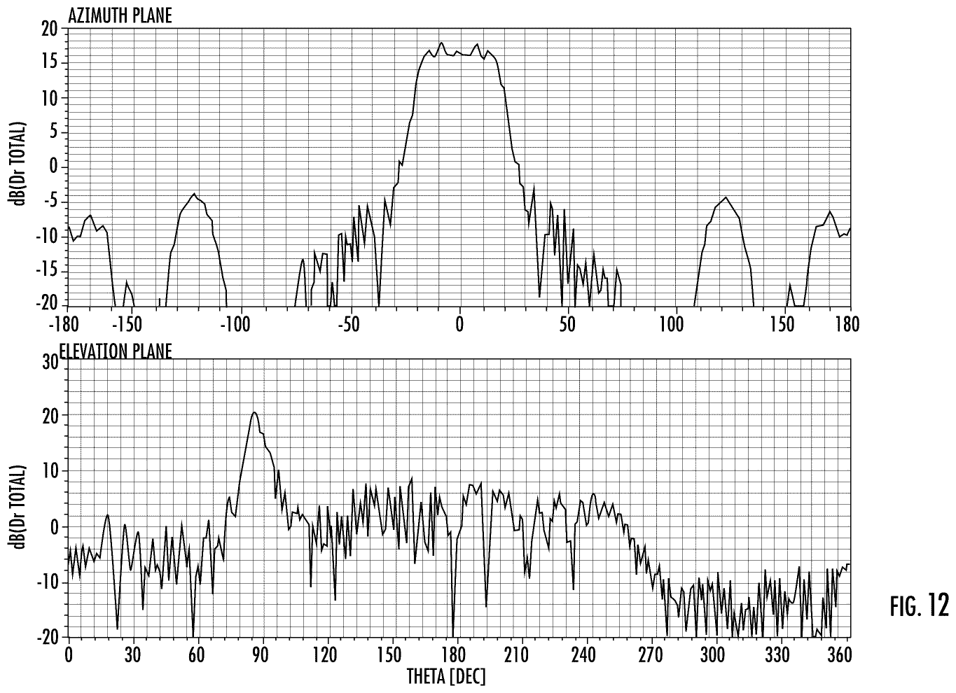

FIG. 10A illustrates how each unit cell 140 is defined by a first conductive loop 142 and four quarter second conductive loops 144. This unit cell 140 is repeated on a dielectric substrate 146. Each loop, whether it is a first conductive loop 142 or a second loop is fabricated from a conductive material, such as copper. These loops may be printed or otherwise fabricated on a surface of the dielectric substrate 146.

Referring to both FIG. 10A and FIG. 10B, as a non-limiting example, the array of unit cells 140 may have a step d within a range of 4 mm to 5 mm, including endpoints. The first conductive loop 142 may have a length lh within a range of 1.7 mm to 2.9 mm, including endpoints, and the second conductive loop 144 may have a length lv within a range of 1.3 m to 2.9 mm, including endpoints. The first conductive loop 142 and the second conductive loop 144 may each have a loop width w and a slot width within a range of 0.085 mm to 0.215 mm, including endpoints. The dielectric substrate may have a thickness of about 0.7 mm, and may be low-loss grounded glass, with a permittivity of about 4.6, for example. It should be understood that these values are provided for illustrative purposes only.

FIG. 11 illustrates directivity plots of the forward gain in the azimuth plane and the elevation plane of an example metasurface reflector for a horizontally polarized 28 GHz source.

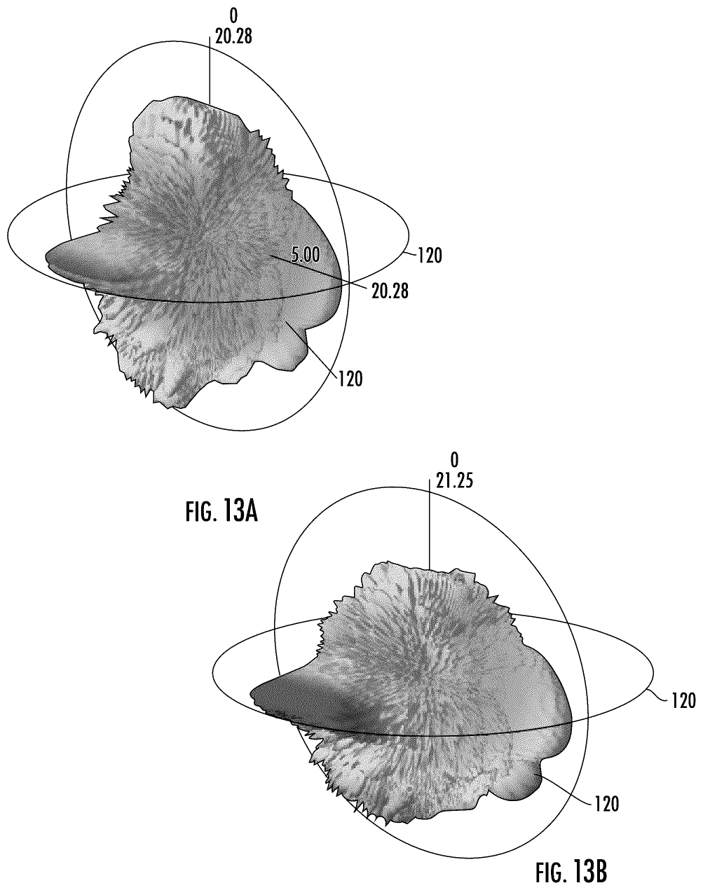

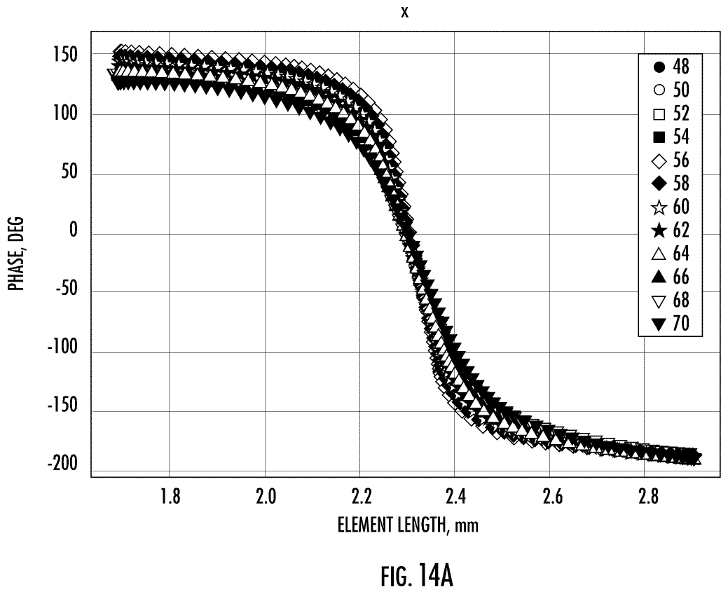

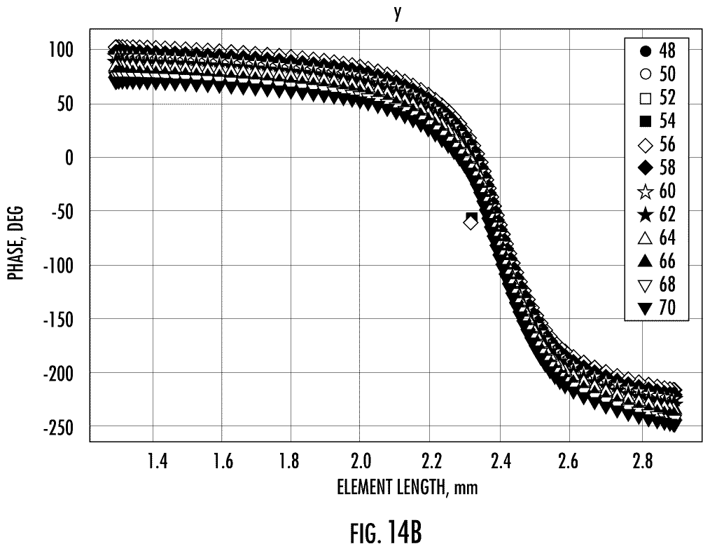

FIG. 12 illustrates directivity plots of the forward gain the azimuth plane and the elevation of an example metasurface reflector for a horizontally polarized 28 GHz source. The maximum values of the metasurface reflector directivities are 20.3 and 21.25 dBi for TE and TM polarizations, respectively. FIG. 13A is a three-dimensional directivity plot of a metasurface reflector excited by a horizontally polarized source at 28 GHz. FIG. 13B is a three-dimensional directivity plot of a metasurface reflector excited by a vertically polarized source at 28 GHz.

The length lg/lv of the first conductive loop 142 and the second conductive loop 144 of the unit cell 140 affects the phase of the reflected wave. FIG. 14A shows the dependence of the phase of the reflected wave versus conductive loop length lg/lv for different angles of incidence of a horizontally polarized source.

Similarly, FIG. 14B shows the dependence of the phase of the reflected wave versus conductive loop length lg/lv for different angles of incidence of a vertically polarized source.

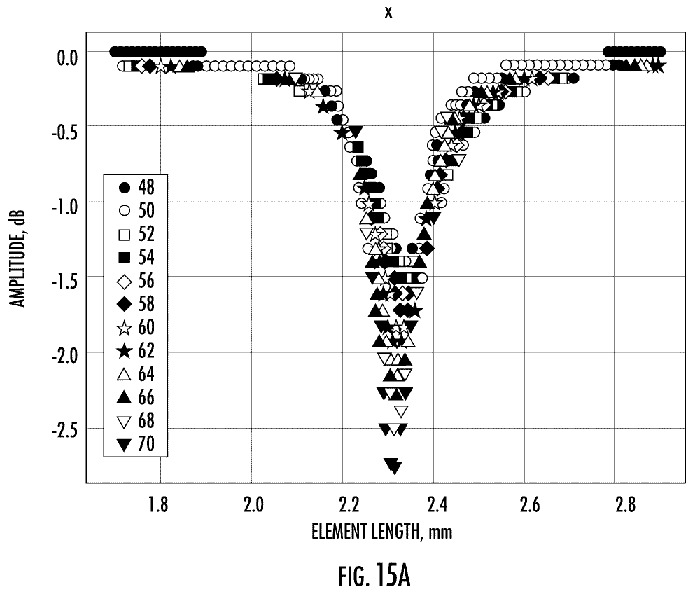

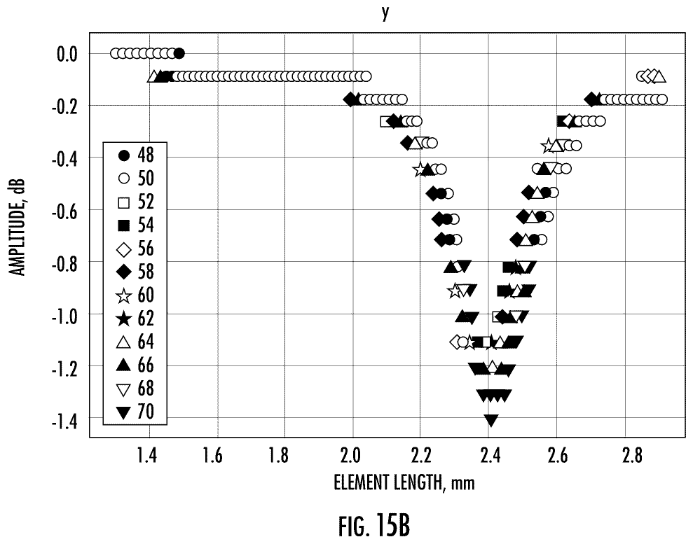

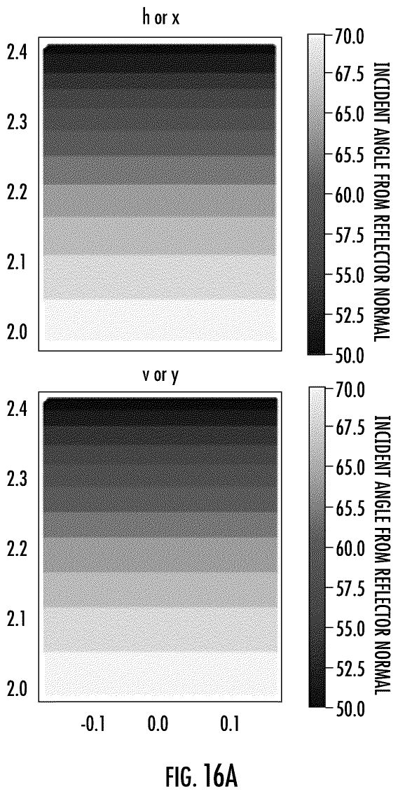

Additionally, the length lg/lv of the first conductive loop 142 and the second conductive loop 144 of the unit cell 140 affects the amplitude of the reflected wave. FIG. 15A plots the amplitude versus conductive loop length lg/lv for different angles of incidence of a horizontal source. Similarly, FIG. 15B plots the amplitude versus conductive loop length lg/lv for different angles of incidence of a vertical source.

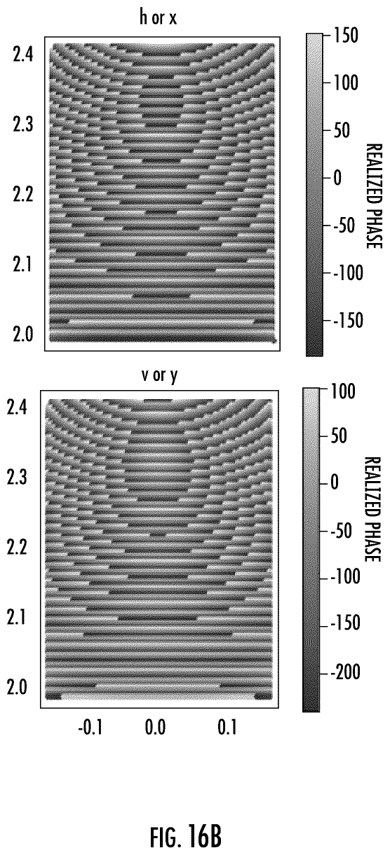

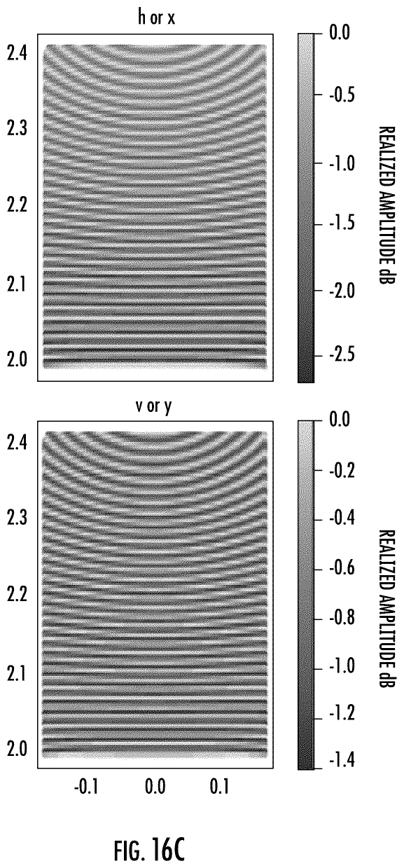

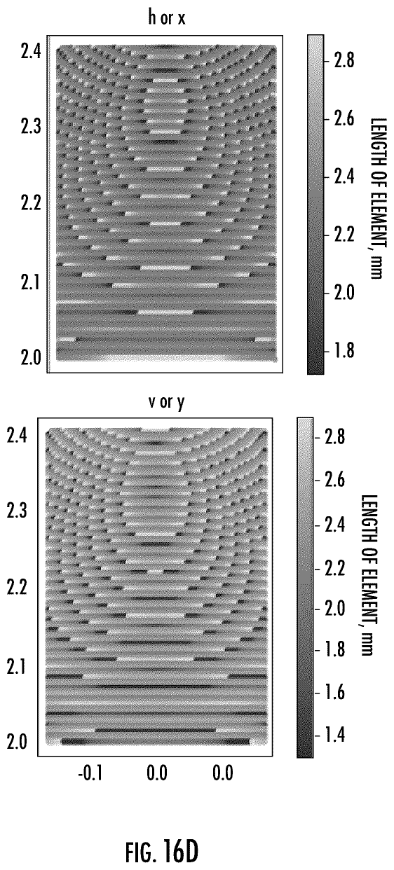

Therefore, the lengths of the individual first conductive loops 142 and the second conductive loops 144 can be optimized to design a metasurface reflector having a desired phase and amplitude response. FIGS. 16A-16D depicts maps of various local quantifies over the surface of an optimized metasurface reflector having an area of 0.35×.0.45 m. In each of FIGS. 16A-16D, the top map (h or x) refers to horizontal elements and the bottom may (v or y) refers to vertical elements. FIG. 16A depicts the angle φf incidence on the metasurface reflector. The vertical axis represents z coordinate of the unit cell in global coordinates (relative to floor, and assuming Tx is installed at the height of 2.7 meters). The Horizontal axis represents X or Y offset of the unit cell in the reflector plane from the center of the reflector.

FIG. 16B depicts the realized phase response due to the optimized surface of the metasurface reflector. FIG. 16C depicts the realized amplitude response resulting from the optimized surface of the metasurface reflector. FIG. 16D depicts the lengths of the first conductive loops (horizontal loops) and the second conductive loops (vertical loops) along the optimized surface of the metasurface reflector. The patterns depicted by FIG. 16D produce the phase response and the amplitude response illustrated by FIG. 16B and FIG. 16C, respectively.

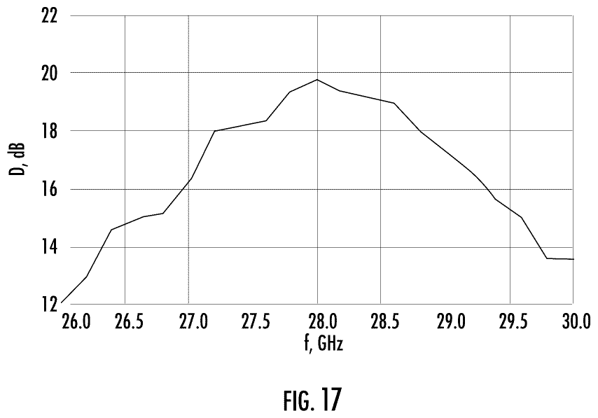

Frequency of the node beam also affects directivity of the reflected beam. FIG. 17 shows the dependent of reflector directivity on frequency, and shows 3 dB bandwidth is within 27.1 GHz and 29.2 GHz (7.5%).

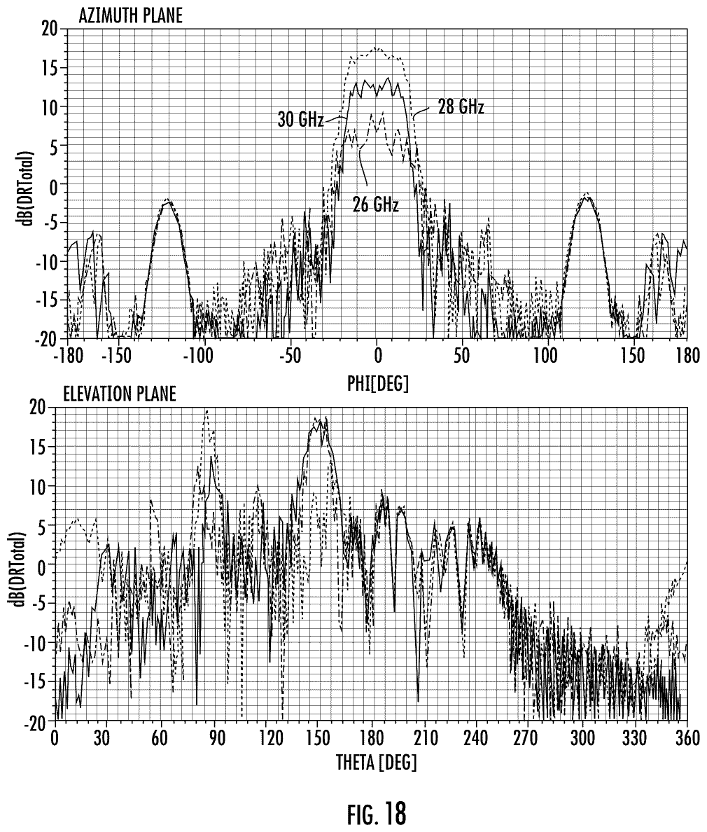

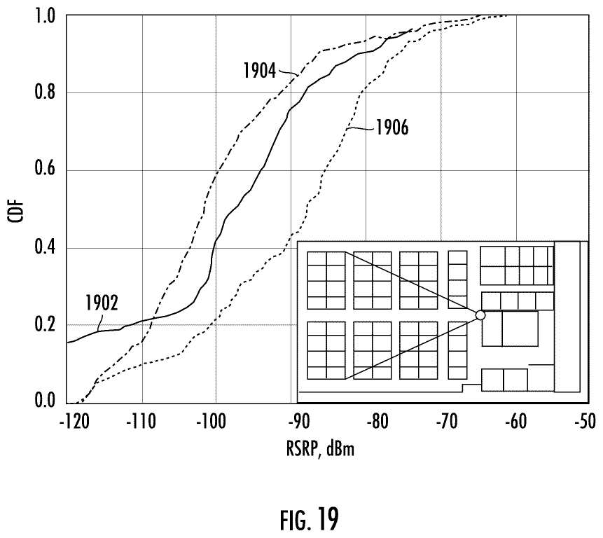

FIG. 18 provides directivity plots for both the azimuth plane and the elevation plane at the surface of the metasurface reflector for different frequencies. Particularly, the top directivity plot plots the forward gain versus the azimuth angle φf steering o, and the bottom directivity plot plots the forward gain versus the elevation steering angle θ.

The effect of placement of the radio node and the use of an optimized metasurface reflector in a 60×20 m office area was modeled in three different scenarios. FIG. 19 illustrates the results of the three scenarios in a plot of the cumulative distribution function (CDF) across the office area versus the reference signal received power (RSRP). Scenario 1 (curve 1902) and Scenario 2 (curve 1904) are comparative scenarios. In Scenario 1, the radio node was placed on the ceiling in the middle of the room. In Scenario 2 the radio node was placed on the ceiling near a right wall with no reflector present. In Scenario 3 the radio node was placed on the ceiling near the right wall with a metasurface reflector designed as described herein. In the scenarios, the radio node is operated at the same codebook with standard beams. However, for Scenario 3 one of the standard beams is operated as a special beam that is optimized for reflection by the metasurface reflector as described herein.

FIG. 19 shows the performance gains obtained by the use of the metasurface reflector and optimized special beam. Comparing curve 1902 of Scenario 1 with curve 1906 of Scenario 3, coverage of RSRP≥−100 dBm is improved by 20% (curve 1902 has 40% of its points having RSRP<−100 dBm, while curve 1906 has 20% of its points having RSRP<−100 dBm). Similarly, comparing curve 1904 of Scenario 2 with curve 1906 of Scenario 3, coverage of RSRP>−100 dBm is improved by 35%. Further 50% of the points of curve 1904 of Scenario 2 have RSRP values at least-101 dBm, whereas 50% of the points of curve 1906 of Scenario 3 have RSRP values of at least-89 dBm, which is a 12 dB improvement.

Accordingly, the proposed metasurface reflector may allow getting up to a 20% reduction of the weak signal area, relative to the total area, when compared against reference coverage with the radio node at an optimal central location. Further, if the same location of a radio node is considered with and without a metasurface reflector, then the metasurface reflector can introduce reduction of the weak signal area by 35% of the total area.

It should now be understood that embodiments of the present disclosure are directed to metasurface reflectors and methods of placing metasurface reflectors and radio nodes in spaces for optimal performance. Particularly, embodiments provide for optimized deployment of passive metasurface reflectors to improve signal coverage, user throughput, transmission delay, reliability and quality of service (QoS) of mmWave systems without significantly increasing total cost of ownership (TCO) and power consumption. Alternative conventional techniques (e.g., increasing transmitted power, relay and additional active mmWave radio nodes) increase system complexity, infrastructure wiring, power consumption and TCO. Further, favorable RF channel propagation and smart radio environment is enabled by minimizing wasted energy, maximizing harvested energy on the reflector surface and redirecting captured energy efficiently to the desired direction without increasing power consumption, extra wiring of new infrastructure and total cost of ownership TCO. Embodiments enable a ceiling mounted radio node close to a metasurface reflector mounted on a wall that is phase-engineered to behave as a wall-mounted radio node to optimize signal using more degree of freedom,, such as reflector size, reflector location, reflector design, codebook design, radio node location and flexible reflected beam width (or beam shape) control beyond present antenna array capabilities.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

What is claimed is:

1. A metasurface reflector array comprising:
a primary metasurface reflector operable to be positioned on a first surface to reflect a primary node beam from a radio node positioned on a second surface transverse to the first surface, wherein a center of the primary metasurface reflector has a first vertical offset dz1 on the first surface;
a pair of secondary metasurface reflectors operable to be positioned on adjacent sides of the primary metasurface reflector, each secondary metasurface reflector of the pair of secondary metasurface reflectors operable to reflect a secondary node beam from the radio node, wherein a center of each secondary metasurface reflector has a second vertical offset dz2 on the first surface that is greater than the first vertical offset dz1; and
a pair of tertiary metasurface reflectors operable to be positioned on adjacent sides of the pair of secondary metasurface reflectors, each tertiary metasurface reflector of the pair of tertiary metasurface reflectors operable to reflect a tertiary node beam from the radio node, wherein a center of each tertiary metasurface reflector has a third vertical offset dz3 on the first surface that is less than the second vertical offset dz2 and greater than the first vertical offset dz1.

2. The metasurface reflector array of claim 1, further comprising a pair of quaternary metasurface reflectors operable to be positioned on adjacent sides of the pair of tertiary metasurface reflectors, each quaternary metasurface reflector of the pair of quaternary metasurface reflectors operable to reflect a quaternary node beam from the radio node, wherein a center of each quaternary metasurface reflector has a fourth vertical offset z4 on the first surface that is greater than the second vertical offset dz2.

3. The metasurface reflector array of claim 1, wherein the primary metasurface reflector, the pair of secondary metasurface reflectors, and the pair of tertiary metasurface reflectors are rectangular in shape.

4. The metasurface reflector array of claim 3, wherein at least one of the primary metasurface reflector, the pair of secondary metasurface reflectors, and the pair of tertiary metasurface reflectors is oriented vertically on the first surface, and at least one of the primary metasurface reflector, the pair of secondary metasurface reflectors, and the pair of tertiary metasurface reflectors is oriented horizontally on the first surface.

5. The metasurface reflector array of claim 1, wherein the first surface is a wall and the second surface is a ceiling.

6. The metasurface reflector array of claim 1, wherein a center of the radio node is operable to be horizontally offset from the center of the primary metasurface reflector by a distance within a range of 25 cm to 50 cm, including endpoints, and is vertically offset from the center of the primary metasurface reflector by a distance within a range of 50 cm to 75 cm, including endpoints.

7. The metasurface reflector array of claim 1, wherein each metasurface reflector of the metasurface reflector array comprises:
a dielectric substrate; and
an array of unit cells defined by an array of first conductive loops and an array of second conductive loops, wherein:
the reflector array is provided on a surface of the dielectric substrate;
the array of first conductive loops is orthogonal to the array of second conductive loops; and
each unit cell provides a phase response for two different polarizations.

8. The metasurface reflector array of claim 7, wherein the dielectric substrate is glass.

9. The metasurface reflector array of claim 7, wherein the first conductive loops and the second conductive loops of the array of first conductive loops and the array of second conductive loops are rectangular loops.

10. The metasurface reflector array of claim 9, wherein:
the array of unit cells has a step within a range of 4 mm to 5 mm, including endpoints;
individual first conductive loops of the array of first conductive loops have a length within a range of 1.7 mm to 2.9 mm, including endpoints;
individual second conductive loops of the array of second conductive loops have a length within a range of 1.3 m to 2.9 mm, including endpoints; and
individual first conductive loops of the array of first conductive loops and individual second conductive loops of the array of second conductive loops each have a loop width within a range of 1.85 mm to 2.15 mm, including endpoints, and a slot width within a range of 1.85 mm to 2.15 mm, including endpoints.

11. A method of positioning one or more metasurface reflectors on a first surface relative to a radio node positioned on a second surface that is transverse to the first surface, the method comprising:
emitting, by the radio node, a radio node beam having an elevation steering angle θ and an azimuth steering angle ¢;
varying the elevation steering angle θ over a plurality of angle values;
for each elevation steering angle θ, varying a horizontal distance from the radio node to the first surface over a plurality of distance values resulting in a plurality of angle value and distance pairs;
for each angle value and distance value pair:
calculating a beam gain for a plurality of points within an area on the surface;
determining a peak gain location within the area providing a maximum beam gain;
determining a flux metric F for a plurality of virtual frame positions at the second surface, wherein each virtual frame position has an area defined by a metasurface reflector and encompasses the peak gain location; and
determining an individual virtual frame position among the plurality of virtual frame positions providing a maximum flux metric F;
selecting an individual angle value and distance pair resulting in a largest maximum flux metric F among the plurality of angle value and distance pairs; and
positioning the radio node on the second surface at a distance from the first surface according to the individual angle value and distance pair;
positioning the metasurface reflector on the first surface at a location according to the individual frame position providing the maximum flux metric F of the individual angle value and distance pair.

12. The method of claim 11, wherein the plurality of distance values cover a range from 20 cm to 10 meters, including endpoints.

13. The method of claim 11, wherein the metasurface reflector comprises:
a dielectric substrate; and
an array of unit cells defined by an array of first conductive loops and an array of second conductive loops, wherein:
the reflector array is provided on a surface of the dielectric substrate;
the array of first conductive loops is orthogonal to the array of second conductive loops; and
each unit cell provides a phase response for two different polarizations.

14. The method of claim 13, wherein the dielectric substrate is glass.

15. The method of claim 13, wherein the first conductive loops and the second conductive loops of the array of first conductive loops and the array of second conductive loops are rectangular loops.

16. The method of claim 13, wherein:
the array of unit cells has a step within a range of 4 mm to 5 mm, including endpoints;
individual first conductive loops of the array of first conductive loops have a length within a range of 1.7 mm to 2.9 mm, including endpoints;
individual second conductive loops of the array of second conductive loops have a length within a range of 1.3 m to 2.9 mm, including endpoints; and
individual first conductive loops of the array of first conductive loops and individual second conductive loops of the array of second conductive loops each have a loop width within a range of 1.85 mm to 2.15 mm, including endpoints, and a slot width within a range of 1.85 mm to 2.15 mm, including endpoints.

17. The method of claim 13, further comprising positioning an additional metasurface reflector on the first surface relative to the radio node by:
determining a horizontal position for the additional metasurface reflector on the first surface such that it is adjacent to a side of the metasurface reflector;
emitting, by the radio node, a secondary radio node beam having an elevation steering angle θ and an azimuth steering angle φ, wherein the azimuth steering angle φ for the secondary radio node beam is established by the horizontal position of the additional metasurface reflector;
varying the elevation steering angle θ of the secondary radio node beam over a plurality of angle values;
for each angle value of the elevation steering angle θ of the secondary radio node beam:
determining an additional peak gain location within an additional area providing a maximum beam gain;
determining the flux metric F for a plurality of additional virtual frame positions at the second surface, wherein each additional virtual frame position has an area defined by the additional metasurface reflector and encompasses the additional peak gain location; and
determining an individual additional virtual frame position among the plurality of additional virtual frame positions providing a maximum flux metric F;
selecting an individual elevation steering angle θ resulting in a largest maximum flux metric F among the plurality of angle values; and
positioning the additional metasurface reflector on the first surface at the individual virtual frame position corresponding with the individual elevation steering angle θ resulting in the largest maximum flux metric.

18. A wireless communication system comprising:
a radio node configured to emit radio node beams;
a primary metasurface reflector operable to be positioned on a first surface to reflect a primary node beam from the radio node positioned on a second surface transverse to the first surface, wherein a center of the primary metasurface reflector has a first vertical offset dz1 on the first surface;
a pair of secondary metasurface reflectors operable to be positioned on adjacent sides of the primary metasurface reflector, each secondary metasurface reflector of the pair of secondary metasurface reflectors operable to reflect a secondary node beam from the radio node, wherein a center of each secondary metasurface reflector has a second vertical offset dz2 on the first surface that is greater than the first vertical offset dz1; and
a pair of tertiary metasurface reflectors operable to be positioned on adjacent sides of the pair of secondary metasurface reflectors, each tertiary metasurface reflector of the pair of tertiary metasurface reflectors operable to reflect a tertiary node beam from the radio node, wherein a center of each tertiary metasurface reflector has a third vertical offset dz3 on the first surface that is less than the second vertical offset dz2 and greater than a first vertical offset z1.

19. The wireless communication system of claim 18, further comprising a pair of quaternary metasurface reflectors operable to be positioned on adjacent sides of the pair of tertiary metasurface reflectors, each quaternary metasurface reflector of the pair of quaternary metasurface reflectors operable to reflect a quaternary node beam from the radio node, wherein a center of each quaternary metasurface reflector has a fourth vertical offset z4 on the first surface that is greater than the second vertical offset dz2.

20. The wireless communication system of claim 18, wherein a center of the radio node is horizontally offset from the center of the primary metasurface reflector by a distance within a range of 25 cm to 50 cm, including endpoints, and is vertically offset from the center of the primary metasurface reflector by a distance within a range of 50 cm to 75 cm, including endpoints.
